(19) United States
(12) Patent Application Publication
(10) Pub. No.: US 2009/0275492 A1
(43) Pub. Date: Nov. 5, 2009

(54) Method Composition and Use

(75) Inventors: Karlheinz Ulrich Hahn, Ludwigshafen (DE); Karl Ludwig Gibis, Limburgerhof (DE); Karin Werner, Ludwigshafen (DE)

Correspondence Address: NORRIS, MCLAUGHLIN & MARCUS, 875 THIRD AVE, 18TH FLOOR, NEW YORK, NY, 10022, US

(73) Assignee: Reckitt Benckiser N.V., Hoofddorp (NL)

(21) Appl. No.: 12/296,765

(22) PCT Filed: Apr. 18, 2007
(86) PCT No.: PCT/GB07/01394

§ 371 Date: Nov. 17, 2008

(30) Foreign Application Priority Data
Apr. 18, 2006 (GB) 0607562.6

(51) Int. Cl. C11D 3/60

(52) U.S. Cl. 510/229; 510/220; 510/231

(57) ABSTRACT

A method of reducing rust in an automatic dishwasher comprises providing a rust-combating composition in the cleaning cycle of the dishwasher. The rust-combating composition be an organic acid. Preferred organic acids are oxalic acid and ascorbic acid. A passivating agent may be present, for example a phosphoric acid, a phosphate or a silicate.

### TECHNICAL FIELD

The present invention relates to a method carried out in an automatic dishwasher. It relates in particular to a method of combating rust on stainless steel items. It further relates to an associated composition and use.

### BACKGROUND AND PRIOR ART

Stainless steels are in general iron alloys containing iron together with one or more alloy metals. The alloy metals may be noble metals, for example chromium, nickel, etc. Due to these alloy metals the surface of stainless steel is protected against rusting by a passivation layer. In normal use this passivation layer gives enough protection to prevent any rusting, even in humid climatic conditions. Further, certain acids, which would attack low alloy steels, do not attack stainless steels.

In cleaning stainless steels in an automatic dishwasher there is the risk that the stainless steels will suffer corrosion. Such corrosion takes the form mainly of spotting, local corrosion and rust pitting. These failings are the cause of consumer complaints. The resistance of stainless steels was discussed in Stiftung Warentest, February 2004, on page 64. Spotting is believed to be caused by an oxidation process at the steel surface without destruction of the steel itself.

Such problems are greater in steel kitchenware items which are generally of lower quality, using a reduced amount of alloy metals. For example low alloy stainless steel with only 13 wt % chromium (so-called “rostfrei”, in German) suffers from rust pitting corrosion quite readily.

A recent explanation for rust pitting is published in Nature, Vol. 415, 14, Feb. 2002, pp 770-774, where it is stated that “significant reduction in the Cr:Fe ratio of the steel matrix around MnS particles” is responsible for the occurrence of rust pitting. This rust pitting is favoured if chlorine ions are present during dishwashing. Their source in the dishwasher could be soils or salt residues from the regeneration process of the ion exchanger or from the salt which may be present in dishwashing cleaning compositions.

Modern dishwashing detergents increase the risk of rust putting on stainless steels. Compared to former so-called “corrosive” detergents with a high amount of metasilicate at a dosage of 40 to 60 g per wash, modern detergents with enzymes typically contain only a low amount of disilicate. Moreover the dosage per wash has been reduced by half. Both facts are responsible for the relatively low alkalinity of the wash water in the main wash cycle. The lower the alkalinity the higher the risk of rust pitting. The reduction in the silicate amount increases the likelihood of rust pitting.

The tendency of new dishwashers to extend the duration of the dishwashing cycle also increases the time that stainless steel is exposed to conditions which promote corrosion. Moreover, the amount of water in one cycle is becoming less and less, as dishwashers develop. Therefore the concentration of damaging species such as chloride ions is becoming higher and higher.

For these various reasons more and more consumers are complaining about rust pitting of their stainless steel kitchenware articles, such as bowls, pots, pans, trays and cutlery. The blades of knives are most affected, as they usually contain the lowest amount of alloying metals responsible for passivation. Nevertheless, other cutlery pieces, stainless steel pots and pans and other dishes made from stainless steel are affected by rust pitting.

Most automatic dishwashing machines incorporate steel components. Although these components are generally of high alloy stainless steel, they are nevertheless susceptible to rust pitting corrosion.

Rust removers are available. The use of such cleaners means burdensome and unpleasant work for consumers. They have to rub a composition onto each single item showing rust, by hand, until the rust is removed. Afterwards they have to rinse the items, again a manual task. Moreover, such cleaners are very aggressive to skin and eyes. This means that gloves are necessary for the de-rusting procedure. Such rust treating cleaners consists of acids such as tannic acid, hydrochloric acid and/or phosphoric acid as actives. In some cleaners oxalic acid is present; (see, for example CA 02273121). Moreover, abrasives like pumices or microcrystalline silica are used. However, abrasives are undesirable, as they create micro-scratches on the surfaces of steel items. Moreover abrasives are not; suitable for the treatment of rust in an automatic dishwasher. They could harm dishwasher machine parts like bearings and sealing gaskets, and cause scratching of internal surfaces of the dishwasher.

WO 94/16045 discloses the use of various dicarboxylic acids as corrosion inhibitors in a machine dishwashing operation. These acids are used as part of a dishwashing or rinse aid composition or are added directly to the rinse water. The compositions have alkaline pHs when diluted.

For inorganic acids as phosphoric acid the concentration of the acid required is the largest issue. Rust removers based on phosphoric acid are generally aqueous and usually require a concentration of phosphoric acid of around 10 wt % in order to be effective. As a dishwasher typically uses around 4 to 5 litres of water in the main wash cycle the amount of concentrated phosphoric acid (e.g. 25 wt %) that would be required to be effective is around 2 litres. The use of such a large amount of concentrated phosphoric acid is clearly impractical due to cost, safety and environmental issues. Moreover, there is a risk that the use of phosphoric acid in the main wash of the dishwasher would tarnish low alloy stainless steel, e.g. blackening it and/or reducing its shine.

Corrosion protection of metal surfaces by a process including passivation is known. For example DE 10010758 discloses passivation using complex fluorides of Ti, Zr, Hf, Si and/or B and organic polymers. WO 2004/101850 discloses pre-treatment of steel surfaces by using a phosphatising solution containing Zn ions, phosphate ions and Ti/Zr compounds. Also the use of a homopolymer or copolymer of vinyl phrrolidone is known for the corrosion protection of a metal surface; see for example WO 03/02781.

Taking into account the problems described above, there is no possibility to simply transfer current state of the art rust removers for use inside a household dishwasher, with satisfactory results.

It is an object of the present invention to solve or reduce the problems outlined above.

The invention is based on the realisation that rust can, in fact, be combated within a dishwasher.

### STATEMENT OF INVENTION

According to a first aspect of the present invention there is provided a method of combating rust in an automatic dishwasher, the method comprising providing an acidic rust-combating composition in the dishwashing cycle of the dishwasher.

In this specification the term dishwashing cycle means the entire dishwashing operation, including a main wash and a rinse stage; optionally a pre-wash; and optionally an intermediate stage; and optionally a rinse aid delivery stage.

The method may be carried out to combat rust on stainless steel kitchenware items using a regular cleaning cycle in which the dishwasher is loaded with a load which includes the stainless steel kitchenware items, but also includes other, non-stainless steel items which may include crockery, bowls, glassware, pots and dishes.

More preferably, the method may be carried out to combat rust on stainless steel kitchenware items using a regular cleaning cycle in which the dishwasher is loaded only with stainless steel kitchenware items.

The method may be one in which the machine itself is to be cleaned. The internal surfaces of dishwashers may become scaled and/or corroded, and machine cleaner compositions are available. Machine cleaning is typically effected without a normal load to be washed being present. However it may be carried out while stainless steel kitchenware items requiring anti-rusting treatment are present.

Stainless steel kitchenware items may include cutlery, utensils, bowls, platters, saucepans, pots, pans, dishes and graters. Cutlery is of most importance in the present invention as it is cleaned in the dishwasher most frequently and so is especially susceptible to rust corrosion.

### DETAILED DESCRIPTION

The present invention will now be described in further detail. A rust-combating composition preferably forms a water-soluble iron compound from rust. This could be a soluble Fe³⁺ complex. Preferably, it reduces iron from its oxidation stage 3+ to 2+; Fe²⁺ compounds are usually more water-soluble than Fe³⁺ compounds.

Preferably the rust-combating composition comprises a reducing agent, for example an acid, and/or a salt, and/or an ester thereof.

Alternatively the rust combating composition comprises an oxidising agent. In this case Fe²⁺ in the rust is converted to Fe³⁺. However Fe³⁺ compounds are generally less stable than Fe²⁺ compounds so the use of oxidising agents is less preferred than the use of reducing agents according to the present invention.

Preferably the rust-combating composition comprises an organic acid, and/or a salt and/or an ester thereof.

A preferred rust-combating organic acid is a carboxylic acid, preferably a polycarboxylic acid, preferably a monomeric polycarboxylic acid. Preferably such an acid has from 2 to 4 carboxylic groups and a Relative Molecular Mass (RMM) not exceeding 120. In relation to a salt or ester of such an acid, such definitions apply to the parent acid.

Carboxylic acids which comprise one carboxyl group include, for example, formic acid, acetic acid, propanoic acid, trimethylacetic acid, caproic acid, stearic acid, acrylic acid, benzoic acid, salicylic acid, and anthranilic acid.

Polycarboxylic acids which comprise two carboxyl groups include, for example, oxalic acid, malonic acid, succinic acid, glutaric acid, adipic acid, tartronic acid, maleic acid, fumaric acid, diglycolic acid, (ethylenedioxy)diacetic acid, tartaric acid, malic acid and phthalic acid.

Polycarboxylic acids which contain three carboxyl groups include, for example, citric acid.

Polycarboxylic acids which contain four carboxyl groups include, for example, pyromellitic acid.

As noted above salts or esters of such acids may be used in this invention.

A preferred rust-combating composition is oxalic acid and/or a salt thereof.

Another preferred rust-combating organic acid is ascorbic acid and/or a salt thereof.

Ascorbic acid is known from WO 94/26860 as a silver-corrosion protection agent for use in dishwasher washing agents, especially for low-alkali dishwasher washing agents. However no reference is made therein to the use of this acid for combating rust.

The rust-combating composition can be used alone or in combination with at least one passivating agent, for example a (reducing) phosphorus-containing compound and/or salt and/or ester, preferably a phosphate or phosphorus-containing acid and/or salt and/or ester, for example H₃PO₂, H₃PO₃ or H₃PO₄, and/or a silicon-containing compound, for example a silicate. A passivating agent has to ensure that a protecting layer is formed on the stainless steel, especially on those places where rust pitting was removed. Otherwise, the rust pitting will rapidly occur again, perhaps even in the immediately following rinse cycle, when the rust removing solution is not present any more. Accordingly the method of the present invention also comprises providing a passivating agent in the cleaning cycle.

If oxalic acid and/or a salt or an ester thereof is used, the passivating agent should not tarnish low alloy stainless steel. The passivation (which could also be called re-passivation) can be achieved by forming a hard iron or chromium compound or complex on the surface of stainless steel. This may be achieved using phosphoric acids and/or phosphates in an acidic condition, and/or by forming a protective layer, for example a silicate layer. This may be achieved through using a silicic acid and/or salt and/or ester thereof and such compounds are preferred in/as passivating agents.

A suitable phosphorus containing acid is phosphoric acid (H₃PO₄).

The rust-combating composition and the passivating agent may be provided together; that is, the passivating agent may be contained within the rust-combating composition. Alternatively they may be provided separately. They could be added to the dishwashing cycle at the same time but when added separately the rust-combating composition is preferably added first, followed by the passivating agent. For example the rust-combating composition may be delivered in a pre-wash, and the passivating agent in a main wash. Alternatively the rust-combating composition may be delivered in a main wash, and the passivating agent in a rinse aid delivery stage. Alternatively the rust-combating composition may be delivered in a pre-wash, and the passivating agent in a rinse aid delivery stage. Alternatively they may be delivered sequentially into the same part of the dishwashing cycle, for example during the main wash. They could be released sequentially from one article. This may be achieved, for example, by temperature controlled release, or by pH controlled release, or by any other means which causes sequential release as a result of differential response to ambient conditions in the dishwasher.

The method of the present invention has been found to be surprisingly effective. It has been found that rust can be removed from stainless steel using small amounts of the composition without causing detrimental effects such as lime scale deposition or tarnishing.

The method of the present invention has been found to be effective on steel cutlery and cookware placed in a dishwasher as well as on the dishwasher itself.

Furthermore the rust-combating action is chemical in nature: no manual action is required. This means no more laborious manual rust cleaning and no direct contact with aggressive cleaners. This is especially important for dishwashers with rust pitting as parts of the dishwasher, especially when damaged parts are non-removable and difficult to access.

Additionally it has been observed that the method of the present invention has a long-term benefit (in terms of rust-combating and prevention), for stainless steel. Without wishing to be bound by theory it is believed that the rust-combating composition is able to reduce or remove the rust and cause re-passivation.

Preferably the rust-combating composition used is aqueous. This makes it particularly suitable for use in an automatic dishwasher, with no phase separation issues to deal with. Nonetheless it is possible to employ a rust-combating composition in other physical states, for example powders and/or granulated powders and/or compressed powders (e.g. tablets) and/or gels and/or foam and/or wipes.

Surprisingly it has been found that a small amount of the defined rust-combating composition is sufficient to beneficially treat stainless steel in an automatic dishwasher. This is especially surprising when the amount of water involved in an automatic dishwashing cycle is considered. Generally less than 500 ml of the agents active in combating rust, present in the rust-combating composition, is sufficient, in the method of the present invention. A preferred amount is 40-250 ml, preferably 80-150 ml.

The amount of such active agent(s) present in the rust-combating composition is preferably sufficient to provide a concentration of 0.05 wt % to 10 wt % in one of the wash stages of a dishwasher (for example a pre-wash or main wash or intermediate stage or rinse aid delivery stage), more preferably 0.1 wt % to 5 wt %, most preferably 0.2 to 3 wt %.

Preferred is the use of di-carboxylic acids, for example oxalic acid and/or a vinyl carboxylic acid, for example such as ascorbic acid and/or the salts of those acids, preferably ammonium and alkali salts. Suitable examples include sodium oxalate, ammonium oxalate and, sodium ascorbate; in each case alone or in combination with other organic or inorganic acids.

The amount of passivating agent(s) in the rust-combating composition, when present, is preferably in a range to provide a concentration below 10 wt %, more preferably below 5 wt %, most preferably between 0.1 wt % and 3 wt % in at least one of the stages of a dishwasher (for example a pre-wash or main wash or intermediate stage or rinse aid delivery stage).

All percentage values stated in this specification, unless otherwise stated, denote weight of the stated component as a percentage of the total weight of the composition in which they are contained.

When there may be more than one species of an agent present in a composition—for example more than one species of passivating agent—a percentage value in any percentage definition herein denotes the total amount of passivating agents present.

The use of hydrochloric acid has been found to be unsuitable for use in a dishwasher if it is dispensed in the main wash. It has a good rust removing effect by forming FeCl₃ in the main wash, but the carry-over of chlorine into the last rinse could promote rust pitting on stainless steel, reducing or even negating the benefit achieved in the main wash.

Nevertheless use of an acidic rust-combating composition is preferred. The additional benefit which could be provided by the use such of such an acidic composition in the dishwasher is as a machine cleaner. Existing machine cleaners such as Calgonit® machine cleaner are successful for limescale and fat removing, but not in combating rust.

The pH of the composition before use in the method of the invention (i.e. when un-diluted) is preferably between pH 1 and pH 6, more preferably between 1 and 5, and most preferably between 2 and 4. The preferred pH level can be adjusted for example by exchanging acidic compounds like phosphoric acid against their salts (for example such as sodium phosphate) in a sufficient amount.

A composition suitable for use in the invention may contain an auxiliary material, for example one or more of the following agents: bleach, bleach activator, fragrance, builder, co-builder, surfactant, dye, pH modifying agent, dispersion aid, enzyme, preservative, scale inhibition agent, silver corrosion inhibitor, and glass, ceramic and enamel corrosion inhibitor.

It may be necessary to separate auxiliary materials from the rust-combating composition, and/or a passivating composition when present, in order to prevent unfavoured chemical reactions and interactions of the compounds. Such is within the normal competence of the skilled person.

Preferably the composition has a scale inhibiting agent. Preferred examples of scale inhibition agents include sulphonate polymers preferably in such an amount as to provide concentration of 0.01 wt % to 1 wt % in the main wash of a dishwasher, more preferably 0.05 wt % to 0.5 wt %.

Such a sulphonated polymer preferably comprises a copolymer. Preferably, the copolymer comprises the following monomers:

(I) 50-90% by weight of monoethylenically unsaturated C₃-C₆ monocarboxyic acid;

(II) 10-50% by weight of unsaturated sulphonic acid.

Advantageously, the copolymer comprises:

(I) 60-90%, more preferably 70-85%, especially 75-80%, by weight of one or monoethylenically unsaturated C₃-C₆ monocarboxylic acid;

(II) 10-40%, more preferably 15-30%, especially 20-25% by weight of unsaturated sulphonic acid.

More advantageously the copolymer comprises 77% by weight of one or monoethylenically unsaturated C₃-C₆ monocarboxylic acid and 23% by weight of unsaturated sulphonic acid.

The monoethylenically unsaturated C₃-C₆ monocarboxylic acid is preferably acrylic acid and/or methacrylic acid.

The unsaturated sulphonic acid monomer preferably comprises one or more of the following: 2-acrylamido methyl-1-propanesultonic acid, 2-methacrylamido-2-methyl-1-propanesulphonic acid, 3-methacrylamido-2-hydroxy-propanesulphonic acid, allysulphonic acid, methallyl-sulphonic acid, allyloxybenzenesulphonic acid, methallyl-oxybenzensulphonic acid, 2-hydroxy-3-(2-propenyloxy)-propanesulphonic acid, 2-methyl-2-propene-1-sulphonic acid, styrene sulphonic acid, vinylsulphonic acid, 3-sulphopropyl acrylate, 3-sulphopropyl methacrylate, sulphomethylacrylamide, sulphomethylmethacrylamide, and water soluble salts thereof.

The unsaturated sulphonic acid monomer is most preferably 2-acrylamido-2-propanesulphonic acid (AMPS).

The weight average molecular weight of the copolymer according to the present invention is from 3,000 to 50,000 and preferably from 4,500 to 35,000.

Commercially available examples of the preferred sulphonated polymer are available from Rohm & Haas under the trade names Acusol 587G and Acusol 588G.

In a second aspect of the invention there is provided an acidic rust-combating composition comprising:
a rust-combating compound comprising an acid and/or a salt and/or an ester thereof;
a passivating agent comprising a phosphorus-containing or silicon-containing compound;
and, optionally, a scale-inhibiting agent.

According to the second aspect it is preferred that the acid is a polycarboxylic acid or ascorbic acid.

Optional and preferred features of the second and third aspects are as stated in relation to the first aspect.

In a third aspect of the invention there is the use of an acidic rust-combating composition for the combating of rust on stainless steel, in the cleaning cycle of a dishwasher.

Optional and preferred features of the second and third aspects are as stated in relation to the first aspect.

The invention is further described with reference to the following non-limiting examples.

### EXAMPLES

### Examples 1-6

### Testing of Compositions

Several compositions were tested in an automatic dishwasher

For examples 1-6 the operation selected was: a cold 5 prewash for 5 min; a main wash at 65° C. for 10 min; an intermediate rinse for 3 min; a final rinse at 65° C. and drying for 30 min. The quantity of water used during the entire cycle was 20 litres (for each aqueous step 5 litres). The compositions were dispensed into the main wash.

The rust removal ability, tarnishing and lime-scale deposition issue was measured by testing the rust removal on three different stainless steel knives using 3 samples of each pattern.

Pattern 1: Beckmann & Rommerskirchen: Modell Vento 13/0 Chromium Steel

Pattern 2: Consulting GmbH: Modell Moni

Pattern 3: Steinbach: Modell Star

The samples which displayed rust pitting corrosion were created by running 20 cycles with dishwashing conditions described above dispensing 5 g NaCl in the mainwash in addition to a Calgonit Powerball® Tab. Only items showing clear visible rust pitting after those 20 cycles were used for the rust removal examinations.

The compositions tested, the water hardness and the results are shown in the table below.

| | Example | | | | | |
|---|---|---|---|---|---|---|
| Components | 1 | 2 | 3 | 4 | 5 | 6 |
| Acid | 20 | 20 | 100 | 20 | 60 | 100 |
| (g) | (O) | (O) | (A) | (O) | (A) | (A) |
| H₃PO₄ 85% conc. | 50 | 70 | — | 100 | 50 | — |
| (g) | | | | | | |
| Scale inhibiting | — | — | — | 2 | 2 | — |
| agent (Acusol^{RTM}) | | | | | | |
| (g) | | | | | | |
| Water Hardness | <1° | <1° | <1° | 18° | 18° | 18° |

O = Oxalic Acid
A = Ascorbic acid

### Observations Under Soft Water Conditions (Examples 1-3):

Example 1: Rust removal partial. Some tarnishing, of “Vento” knives only

Example 2: 100% rust removal; no tarnishing

Example 3: 100% rust removal; no tarnishing

### Observations Under Hard Water Conditions (Examples 4-6):

Example 4: 100% rust removal; but some white residues (spots) on knives and on dishwasher surfaces

Example 5: 100% rust removal; no white residues

Example 6: 100% rust removal; no white residues

### Example 7

The protection performance on stainless steel was evaluated using three samples of both cutlery patterns 1 and 2 and 4 samples of pattern 3 (as described in ‘testing of compositions’) displaying rust pitting corrosion.

To achieve the rust pitting 2 g of NaCl was added in the main wash to Calgonit Powerball® Tab and ten dishwasher cycles were run having the conditions described above with the cutlery samples present.

The above samples of each pattern with rust pitting were taken for further testing. A rust removal procedure according to Example 2 was executed. By this pre-treatment the rust was removed from all samples. Washing these de-rusted samples again ten cycles with the 2 g NaCl and Calgonit Powerball® Tab combination caused five samples (50%) to suffer rust pitting, once again. The other five samples stayed “stainless”. Moreover, although the other five samples showed rust pitting, the size and the number of the rust pits were reduced compared with the size and number of rust pits after the pre-treatment and before the rust removal treatment.

1. A method of combating rust in an automatic dishwasher, the method comprising the step of: providing an acidic rust-combating composition in the dishwashing cycle of the dishwasher.

2. A method according to claim 1 wherein the rust-combating composition is a reducing agent.

3. A method according to claim 2 wherein the rust-combating agent is an oxidising agent.

4. A method according to claim 1 wherein the rust-combating composition has a pH of between 1 and 6.

5. A method according to claim 4 wherein the rust-combating composition comprises an organic acid or a salt or an ester thereof.

6. A method according to claim 5 wherein the organic acid comprises ascorbic acid or a salt or an ester thereof.

7. A method according to claim 5 wherein the rust-combating composition comprises a polycarboxylic acid having from 2 to 4 carboxylic acid groups and an RMM not exceeding 120, or a salt or an ester thereof.

8. A method according to claim 7 wherein the rust-combating composition comprises oxalic acid or a salt or an ester thereof.

9. A method according to claim 1 wherein the method comprises the step of: providing a passivating agent in the cleaning cycle.

10. A method according to claim 9 wherein the passivating agent comprising a phosphorous-containing or silicon-containing compound.

11. A method according to claim 10 wherein the passivating agent comprises a phosphorous-containing acid or a salt or an ester thereof.

12. A method according to claim 10 wherein the passivating agent comprises silicic acid or a salt or an ester thereof.

13. A method according to claim 1 wherein the method comprises the step of: providing a phosphorous-containing or silicon-containing compound which provides a rust-combating benefit and a passivating benefit.

14. A method according to claim 13 wherein the method comprises the step of: providing a phosphorous-containing acid or a salt or an ester thereof which provides a rust-combating benefit and a passivating benefit.

15. A method according to claim 14 wherein the method comprises the step of: providing H₃PO₄ or H₃PO₃ or a salt or an ester of any of these acids, which provides a rust-combating benefit and a passivating benefit.

16. A method according to claim 1 comprising providing a scale inhibiting agent.

17. An acidic rust-combating composition comprising:
a rust-combating compound comprising an acid or a salt or an ester thereof;
a passivating agent comprising a phosphorous-containing or silicon-containing compound; and,
optionally, a scale-inhibiting agent.

18. (canceled)
